(19) United States
(12) Patent Application Publication
(10) Pub. No.: US 2021/0076404 A1
(43) Pub. Date: Mar. 11, 2021

(54) METHOD USED BY NETWORK APPARATUS FOR TRANSMITTING BUFFER STATUS REPORT IN MULTI-HOP WIRELESS NETWORK AND NETWORK APPARATUS USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW)

(73) Assignee: Industrial Technology Research Institute, Hsinchu (TW)

(21) Appl. No.: 17/009,757

(22) Filed: Sep. 1, 2020

Related U.S. Application Data
(60) Provisional application No. 62/896,589, filed on Sep. 6, 2019.

(51) Int. Cl. H04W 72/12; H04W 72/14; H04W 40/22

(52) U.S. Cl. CPC H04W 72/1284; H04W 40/22; H04W 72/1242; H04W 72/14

(57) ABSTRACT

The disclosure is directed to a method used by a network apparatus for transmitting a buffer status report in a multi-hop wireless network and a network apparatus using the same method. According to an exemplary embodiment, the method may include not limited to receiving a priority information of a LCH having a highest priority among a plurality of LCHs included in a BSR message which indicates a wireless resource to be needed for upstream data from a child node; determining whether a condition is met based on the priority information; and triggering a pre-emptive BSR message comprising the priority information in response to the condition having been met.

### CROSS-REFERENCE TO RELATED APPLICATION

This application claims the priority benefits of U.S. provisional application Ser. No. 62/896,589, filed on Sep. 6, 2019. The entirety of the above-mentioned patent application is hereby incorporated by reference herein and made a part of this specification.

### TECHNICAL FIELD

The disclosure is directed to a method used by a network apparatus for transmitting a buffer status report in a multi-hop wireless network and a network apparatus using the same method.

### BACKGROUND

Conventionally, a buffer status report (BSR) is a of Media Access Control (MAC) MAC control element (CE) transmitting from a mobile electronic device to a network to convey information related to the amount of data the mobile electronic device is sending out. One purpose of the BSR is to subsequently procure an uplink (UL) grant from the network. The UL grant is typically transmitting to the mobile electronic device through a physical downlink control channel (PDCCH) and to indicate the wireless resource allocated for the data corresponding to the BSR assuming that an UL resource is available.

FIG. 1 shows a multi-hop network including an integrated access and backhaul (IAB) donor node and multiple IAB nodes (e.g. IAB node 1 and IAB node 2 of FIG. 1) serving as a hub and a relay. The IAB donor node would use the architecture which splits between a centralized unit (CU) and a distribution unit (DU) while IAB nodes would use the architecture which splits between a mobile termination (MT) and a DU. In the example of FIG. 1, the IAB donor is wirelessly connected to IAB node 1 which is wirelessly connected to IAB 2 which serves a UE. The principles of operations of the example of FIG. 1 is consistent with a current 5G standard such as TR 38.874. In short, in order for UE to transmit data to a network, the UE would transmit a scheduling request (SR) to IAB node 2 which would then transmit an UL grant to the UE for transmitting the BSR. The UE would subsequently transmit the BSR to IAB node 2 to indicate the amount of data to be transmitted to the network. Upon receiving the BSR, the IAB node 2 would transmit to the UE an UL grant for allocating the wireless resource for the data corresponding to the BSR to be transmitting. Upon receiving the UL grant, the UE would transmit data in protocol data units (PDUs). The same signal procedure would repeat between IAB node 2 and IAB node 1 as well as between IAB node 1 and IAB donor node.

It has been noticed that for the signaling procedure as described for FIG. 1, there would exist a scheduling latency in UL scheduling due to the exchanges of signaling, and the worst-case scenario may occur when none of the intermediate nodes have any UL resources allocated to them. FIGS. 2A & 2B illustrates two options of improving the signaling procedure of a multi-hop network architecture for a 5G communication network. FIG. 2A shows a method by which an IAB node may reduce UL scheduling latency through signaling of an UL grant. For this method, the transmission of an UL grant would mean that there is data available for transmission. Thus, upon transmitting the UL grant (S201), the IAB node 2 would transmit a SR to IAB node 1. Also, upon transmitting the UL grant (S202), the IAB node 1 would transmit a SR to IAB donor node. FIG. 2B shows a method by which an IAB node may reduce UL scheduling latency through signaling of a SR. For this method, the reception of a BSR would mean that there is data available for transmission. Thus, upon reception the BSR (S203), the IAB node 2 would transmit a SR to IAB node 1. Also, upon reception of the BSR (S204), the IAB node 1 would transmit a SR to IAB donor node.

In order to distinguish between predicted data of wireless electronic device to be transmitted in the future (i.e. predictive data) from available data of wireless electronic device to be transmitted currently, a pre-emptive BSR has been proposed to function alongside the regular BSR. A pre-emptive BSR could be distinguished from the regular BSR based on the LCID (Logical Channel Identifier). The regular BSR has been formulated to limit its frequency of being triggered in order to reduce the signaling overhead of a MAC CE. Currently the regular BSR could be triggered if the UL data for a logical channel (LCH) which belongs to an logical channel group (LCG) becomes available to a MAC entity, and either this UL data belongs to a LCH with a higher priority than the priority of any LCH containing available UL data which belong to any LCG or none of the logical channel which belong to an LCG contains any available UL data.

However, in order to limit the triggering of the pre-emptive BSR, the IAB node does not currently know whether to trigger a pre-emptive BSR for predictive data. One possible proposal is having the pre-emptive BSR be triggered if the predictive data is to be transmitted through the LCH having the highest priority. However, such proposal is implemented with further details, may suffer the drawback of triggering pre-emptive redundant BSR due to having already received regular BSR, triggering meaningless pre-emptive BSR due to receiving periodic BSR, and causing a parent IAB node to interpret a wrong SR configuration. Therefore, the solution to trigger the pre-emptive BSR when transmitting predictive data through LCH having the highest priority could not be implemented unless there exist further implementation details to overcome the above described difficulties.

### SUMMARY OF THE DISCLOSURE

Accordingly, in order to limit the pre-emptive BSR to trigger less frequently and in order for an IAB node to know whether to transmit a pre-emptive BSR, the disclosure is directed to a method used by a network apparatus for transmitting a buffer status report in a multi-hop wireless network and a network apparatus using the same method.

In one of the exemplary embodiments, the disclosure is directed to a method used by a network apparatus for triggering a buffer status report in a multi-hop wireless network. The method would include not limited to: receiving a first priority information of a LCH having a highest priority among a plurality of LCHs included in a first regular BSR message which indicates a wireless resource to be needed for upstream data from a child node; determining whether a condition is met based on the first priority information; and triggering a pre-emptive BSR message including the second priority information in response to the condition having been met.

In one of the exemplary embodiments, the disclosure is directed to a network apparatus which includes not limited to: a transmitter, a receiver, and a processor coupled to the transmitter and the receiver. The processor is configured at least to: a transmitter; a receiver; and a processor coupled to the transmitter and the receiver and configured at least to: receive, via the receiver, a first priority information of a LCH having a highest priority among a plurality of LCHs included in a BSR message which indicates a wireless resource to be needed for upstream data from a child node; determine whether a condition is met based on the first priority information; and trigger, via the transmitter, a pre-emptive BSR message including the second priority information in response to the condition having been met.

In order to make the aforementioned features of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also, the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a signaling procedure of a multi-hop network architecture for a 5G communication network.

FIG. 2A illustrates an option of an improved signaling procedure of a multi-hop network architecture for a 5G communication network.

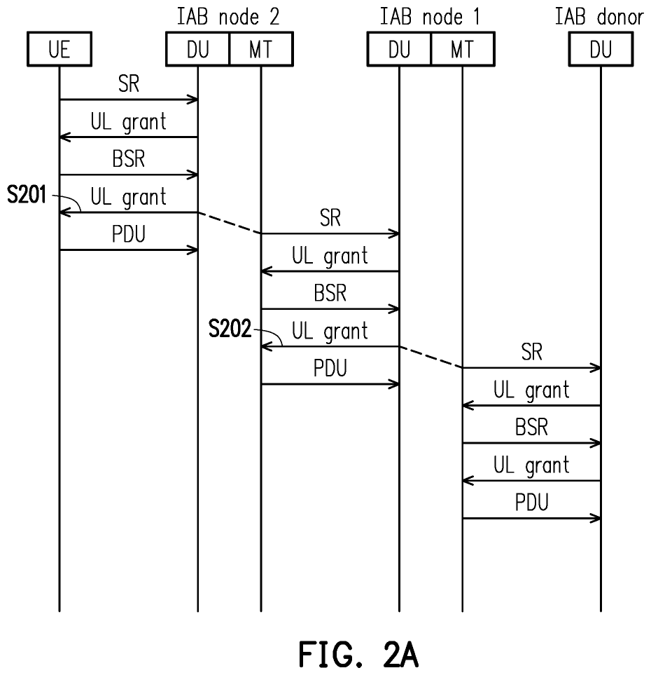

FIG. 2B illustrates another option of an improved signaling procedure of a multi-hop network architecture for a 5G communication network.

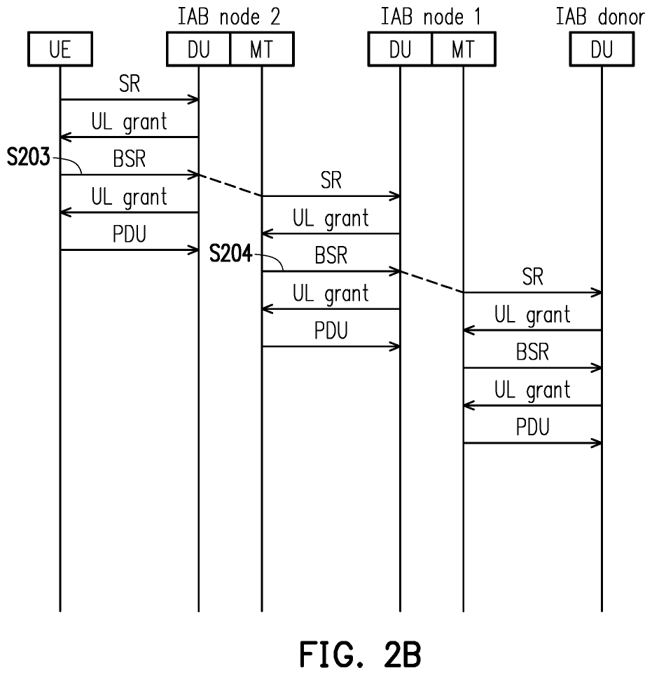

FIG. 3 illustrates a method used by a network apparatus for transmitting a buffer status report in a multi-hop wireless network according to an exemplary embodiment of the disclosure.

FIG. 4 illustrates a conceptual hardware block diagram of a network apparatus in a multi-hop wireless network according to an exemplary embodiment of the disclosure.

FIG. 5 is an example which illustrates the triggering of pre-emptive BSR for predictive data with a 1-1 bearer mapping according to an exemplary embodiment of the disclosure.

FIG. 6 illustrates a first example of a mechanism of triggering a pre-emptive BSR for predictive data according to a first exemplary embodiment of the disclosure.

FIG. 7 illustrates a first alternative of the mechanism of FIG. 6 according to an embodiment of the disclosure.

FIG. 8 illustrates a second alternative of the mechanism of FIG. 6 according to an embodiment of the disclosure.

FIG. 9 illustrates a second example of a mechanism of triggering of pre-emptive BSR for predictive data according to a first exemplary embodiment of the disclosure.

FIG. 10 illustrates a flow chart of implementing the triggering of pre-emptive BSR from the perspective of an intermediate IAB node according to a second exemplary embodiment of the disclosure.

FIG. 11 illustrates a format of pre-emptive BSR implemented in a MAC CE according to a first exemplary embodiment of the disclosure.

FIG. 12 illustrates a format of pre-emptive BSR implemented in a MAC CE according to a second exemplary embodiment of the disclosure.

FIG. 13 illustrates an example of a mechanism of triggering a pre-emptive BSR for predictive data according to a second exemplary embodiment of the disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

In general, the BSR procedure is used to provide a serving gNB with information about UL data volume in a MAC entity. The pre-emptive BSR could be additionally used by an IAB-MT to provide its parent IAB-DU with the information about the amount of the data expected to arrive at the MT of the IAB node from its child node(s) and/or the UE(s) attached to it.

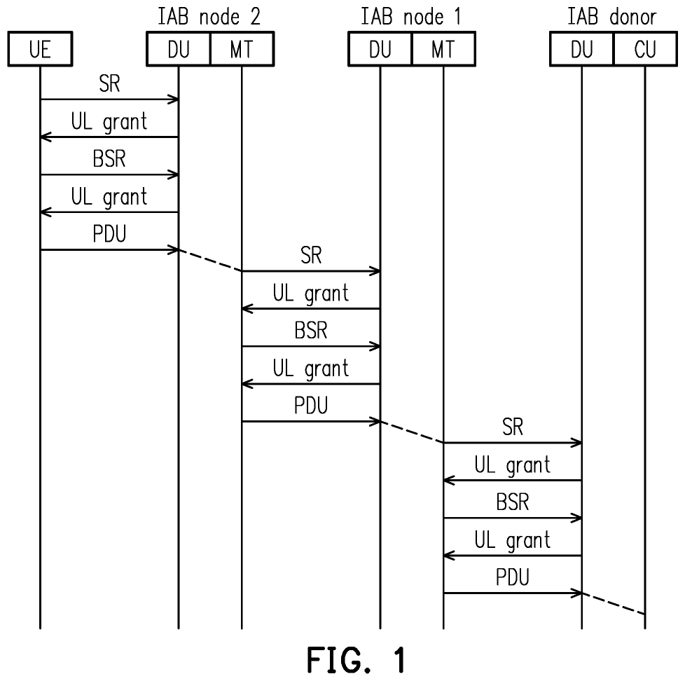

In order to limit the triggering of a pre-emptive BSR for predictive data, the disclosure provides a mechanism which limits the transmissions of pre-emptive BSRs by a network apparatus (e.g. IAB node). A pre-emptive BSR for predictive data of an IAB node is triggered according to a priority information provided from a child IAB node of the IAB node, and the priority information would indicate a highest priority. A child IAB node refers to an IAB node downstream from the IAB node. For example, IAB node 2 in FIG. 1 is a child node of IAB node 1, and IAB node 1 is a parent node of IAB node 2. The priority information indicating a highest priority information refers to a priority of a logical channel with the highest priority among the LCHs which have predictive and/or available data included in the regular BSR provided from its child IAB node. The priority information could be indicated in a MAC CE of the pre-emptive BSR according to two different formats. The first alternative format includes a priority value in a 4-bit field. The second alternative format includes an LCH identifier (ID) in a 6-bit field.

Further, regular BSRs would be cancelled or not triggered when the predictive data for becomes available if the pre-emptive BSR for the predictive data and the regular BSR correspond to the same event. In other words, when the actual data that corresponds to the predictive data has arrived, arrival of the data does not trigger a regular BSR if data arrival event as expected has already triggered a pre-emptive BSR. Thus, if a preemptive BSR is triggered, the regular BSR corresponding to the event is not triggered. When all or high priority expected data have been received after a triggering of a pre-emptive BSR, the subsequent BSRs could be cancelled and thus no more BSR is to be triggered regardless of which LCH belong to the LCG which has predictive data arriving.

Definition of the data volume of predictive data could be defined according to two options. In option 1, the data volume predicted to become available to a MAC entity could be the same as the data volume indicated in an UL grant transmitted by the DU of an IAB node. In option 2, the data volume predicted to become available to the MAC entity could be the same as the data volume indicated in BSRs from child IAB nodes or UEs.

The benefits of the mechanism include limiting the preemptive BSRs to trigger less frequently so as to reduce the signaling overhead associated with transmitting the predictive data and accurately determining a SR configuration which is used by the SR triggered by the corresponding BSR for predictive data. The overall performance may depend on the configuration of an LCG and its corresponding LCHs. In other words, the efficiency may increase when an LCG has more LCHs.

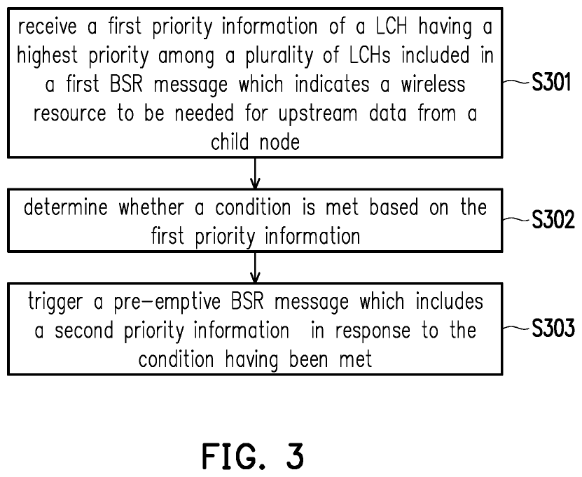

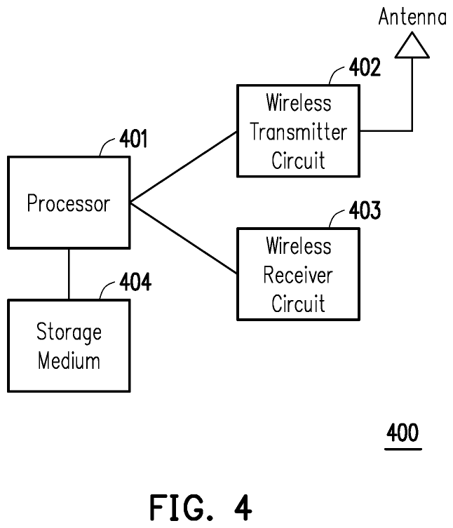

Based on the above described inventive concepts, the disclosure provides a method used by a network apparatus for transmitting a buffer status report in a multi-hop wireless network as shown in FIG. 3 and the corresponding network apparatus as shown in FIG. 4. Referring to the method steps in FIG. 3, in step S301, the network apparatus would receive, by the network apparatus from a child node, a first priority information of an LCH having a highest priority among a plurality of LCHs included in a first BSR message which indicates a wireless resource to be needed for the upstream data from a child node which could be another IAB node or similar device wirelessly connected to the network apparatus from the downstream. In step S302, the network apparatus would determine whether a condition is met based on the first priority information. In step S303, the network apparatus would trigger a pre-emptive message BSR including the second priority information in response to the condition having been met.

According to an exemplary embodiment, the network apparatus would transmit an UL grant which indicates the UL resource to the child node. According to an exemplary embodiment, the priority information may include an LCH ID. Alternatively, the priority information may include a priority of the LCH. According to an exemplary embodiment, the condition includes the priority information in the first regular BSR message transmitted from the child node indicating a higher priority than the priorities of all other LCHs containing predictive or available UL data belonging to an LCG. According to an exemplary embodiment, a second BSR is to be cancelled when the predictive data becomes available if the pre-emptive BSR and the second BSR correspond to the same event. According to an exemplary embodiment, the second BSR message does not indicate the priority information when the priority information of the first BSR message is less than or equal to priorities of any other LCHs containing predictive or available data.

According to an exemplary embodiment, the pre-emptive BSR is located in a MAC CE transmitted through a PUSCH. The above described priority information could be located in a last octet of the pre-empty BSR.

Referring to FIG. 4 which shows a conceptual hardware block diagram of the network apparatus 400. The network apparatus 400 would include not limited to a hardware processor 401, electrically connected to a wireless transmitter circuit 402, a wireless receiver circuit 403, and a non-transitory storage medium 404. The network apparatus 400 could be an IAB node such as IAB-1, IAB-2, and etc, as previously described. The network apparatus 400 is configured at least for implementing the method as described in FIG. 3 and its corresponding exemplary embodiments. The wireless transmitter circuit 402 may include one or more transmitting circuits, and the wireless receiver circuit 403 may include one or more receiving circuits configured to transmit and receive signals respectively in the radio frequency or in the mmWave frequency. The wireless transmitter circuit 402 and wireless receiver circuit 403 may also perform operations such as low noise amplifying, impedance matching, frequency mixing, up or down frequency conversion, filtering, amplifying, and so forth. The wireless transmitter circuit 402 and wireless receiver circuit 403 may each include one or more digital-to-analog (D/A) converters or analog-to-digital (A/D) converters which are configured to convert from a digital signal format to an analog signal format during uplink signal processing or from an analog signal format to a digital signal format during downlink signal processing. The wireless transmitter circuit 402 and wireless receiver circuit 403 may each include an antenna array which may include one or multiple antennas to transmit and receive omni-directional antenna beams or directional antenna beams. The non-transitory storage medium 404 would store programming codes, codebook configurations, buffered data, and/or record configurations assigned by the hardware processor 401. The hardware processor 401 could be implemented by using programmable units such as a micro-processor, a micro-controller, a DSP chips, FPGA, etc. The functions of the hardware processor 401 may also be implemented with separate electronic devices or ICs.

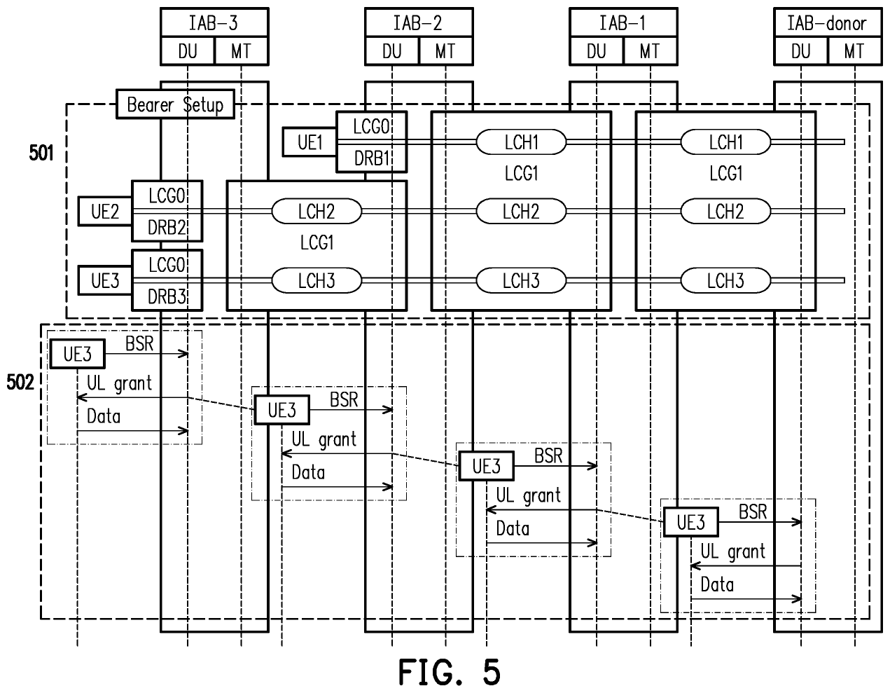

To further explain the above described method and device, the disclosure provides exemplary embodiments and examples as shown in FIG. 5˜FIG. 14 and as described by their corresponding written descriptions. FIG. 5 shows an example of a bearer setup 501 and the UE's signaling procedure 502 for transmitting predictive data in a multi-hop wireless network. For the bearer setup, it is assumed that there are at least three LCHs with LCH1 used for communication between the network and UE 1, LCH2 is used for communication between the network and UE 2, and LCH3 is used for communication between the network and UE3. The LCHs may go through several hops. For example, the LCH1 involves the data traversing via at least IAB-donor, IAB-1, and IAB-2 between the network and UE1, and the LCH2 and LCH3 involves the data traversing via at least IAB-donor, IAB-1, IAB-2, and IAB-3 between the network and UE2 and between the network and UE3. One or more LCHs could be grouped together into an LCG. In this example, LCG1 contains LCH1, LCH2, and LCH3 until between IAB-2 and IAB-3 where LCG1 contains LCH1 and LCH2 as UE1 is its own group, LCG0 and communicates with IAB-2 through data radio bearer (DRB)1. At IAB-3, UE2 and UE3 are each its own LCG group, LCG0, and communicates with IAB-3 through DRB2 and DRB3 respectively.

In order for UE3 to communicate with a network, the signaling procedure 502 is as follows. UE3 would first transmit to IAB-3a regular BSR which indicates the quantity of predictive data to be transmitted. After receiving the regular BSR, the IAB-3 would transmit to UE3 an UL grant which indicates the wireless resource for transmitting the predictive data to the network. In response to transmitting the UL grant, IAB-3 would transmit to IAB-2a preemptive BSR indicating the quantity of data to be expected from UE3. Next, IAB-3 would receive an UL grant from IAB-2 for transmitting the predictive data to IAB-2. Next, the IAB-3 would receive the actual data from UE3. Next, IAB-3 would forward the actual data to IAB-2 by using the UL grant received from IAB-2. The same procedure would apply between IAB-2 and IAB-1 and between IAB-1 and IAB-donor.

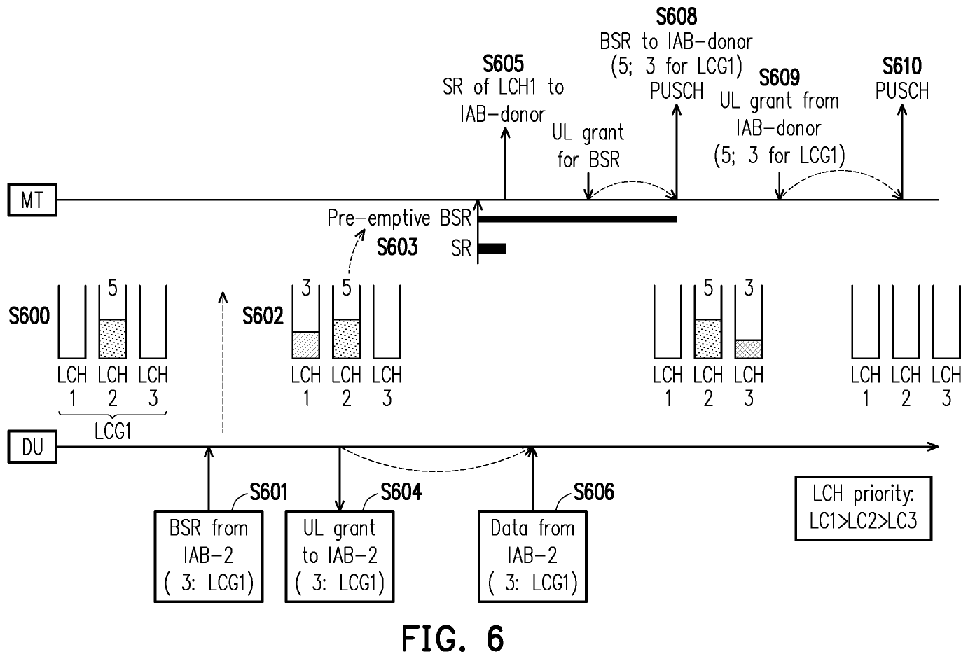

For a first exemplary embodiment, FIG. 6 illustrates a first example of a mechanism of triggering a pre-emptive BSR from the perspective of IAB-1. It is assumed that LCH1 has a higher LCH priority than LCH2, and LCH2 has a higher LCH priority than LCH3. In step S600, it is assumed that LCG1 has LCH1, LCH2, and LCH3, and LCH2 carries 5 units of data. In step S601, IAB-1 receives a regular BSR from IAB-2 indicating 3 units of data to be received in LCG1. It is worth noting that a BSR records data to be transmitted for an entire LCG. In step S602, IAB-1 would determine whether the data belongs to an LCH which has the highest priority among LCG1. In step S603, if the data belongs to LCH1, then a pre-emptive BSR is triggered, but if the data belongs to LCH2 or LCH3, then no pre-emptive BSR is triggered. In step S604, IAB-1 would transmit to IAB-2 an UL grant for the data to be received. In step S605, IAB-1 would transmit to IAB-donor a SR for LCH1 and would subsequently receive from IAB-donor an UL grant for the regular BSR. In step S606, IAB-1 would receive the actual 3 units of data from IAB-2 through LCH3. In step S608, IAB-1 would transmit the regular BSR to IAB-donor through PUSCH by using the UL grant received from IAB-donor, and the BSR would indicates 5 units of data in LCH2 and 3 units of data in LCH3. In step S609, IAB-1 would receive from IAB-donor an UL grant for the 5 units of data in LCH2 and 3 units of data in LCH3. In step S610, the IAB-1 would transmit the data to IAB-donor through PUSCH.

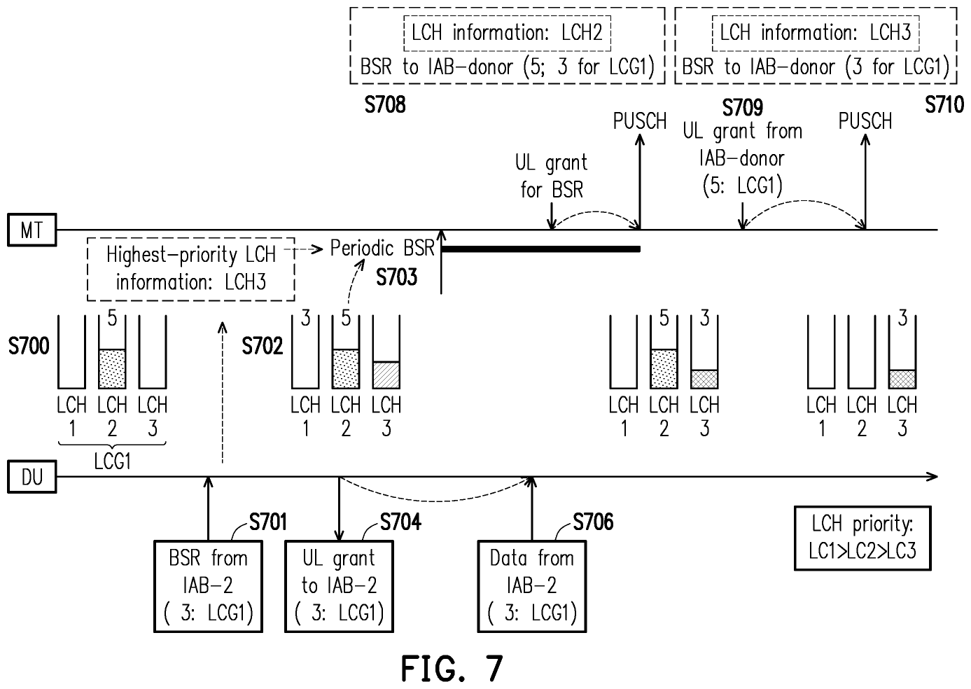

FIG. 7 illustrates a first alternative of the mechanism of FIG. 6 according to an embodiment of the disclosure. The steps of FIG. 7 are similar to the steps of FIG. 6 except for the following descriptions. In step S702, IAB-1 would receive a regular BSR from IAB-2 indicating three further future data units for LCH3 of LCG1 to be transmitted in addition to the 5 units of data from LCH2. The 5 units of data from LCH2 in this example could be data that is to be periodically transmitted and would require a periodic BSR to transmit in the absence of the condition to trigger a BSR. In step S703, IAB-1 would determine the whether there is any highest priority LCH information for LCG1. For IAB-1, the highest priority LCH information refers to one of LCH1, LCH2, and LCH3 that has the highest priority and have predictive and/or available data included in the BSR provided from IAB-2. In step S703, IAB-1 has determined there does not exist any highest priority LCH information in LCG1 since the priority of LCH1 is the highest among LCG1 but there is no data to be transmitted through LCH1. Subsequently, a period (regular) BSR will be transmitted to inform that there will be 5 units of data to be transmitted via LCH2 and 3 units of data to transmitted via LCH3. In step S705, IAB-1 would transmit to IAB-donor a SR for LCH2 and would subsequently receive from IAB-donor an UL grant for the periodic BSR. In step S708, IAB-1 would transmit the periodic BSR to IAB-donor through PUSCH indicating 5 units of data to be transmitted via LCH2 and 3 units of data to be transmitted via LCH3 by using the UL grant received from IAB-donor. Also, in step S708, the BSR would indicate the LCH for carrying the 5 units of data indicated in the BSR (i.e. LCH information: LCH2 in FIG. 7). In this example, the LCH information would be the ID of LCH2. In step S709, IAB-1 would receive from IAB-donor an UL grant for the 5 units of data in LCH2 and 3 units of data in LCH3. In step S710, the IAB-1 would transmit to the IAB-donor a BSR indicating 3 units of data to be transmitted via LCH3 of LCG1, and the BSR would indicate the LCH for carrying the 3 units of data indicated in the BSR (i.e. LCH information: LCH3 in FIG. 7).

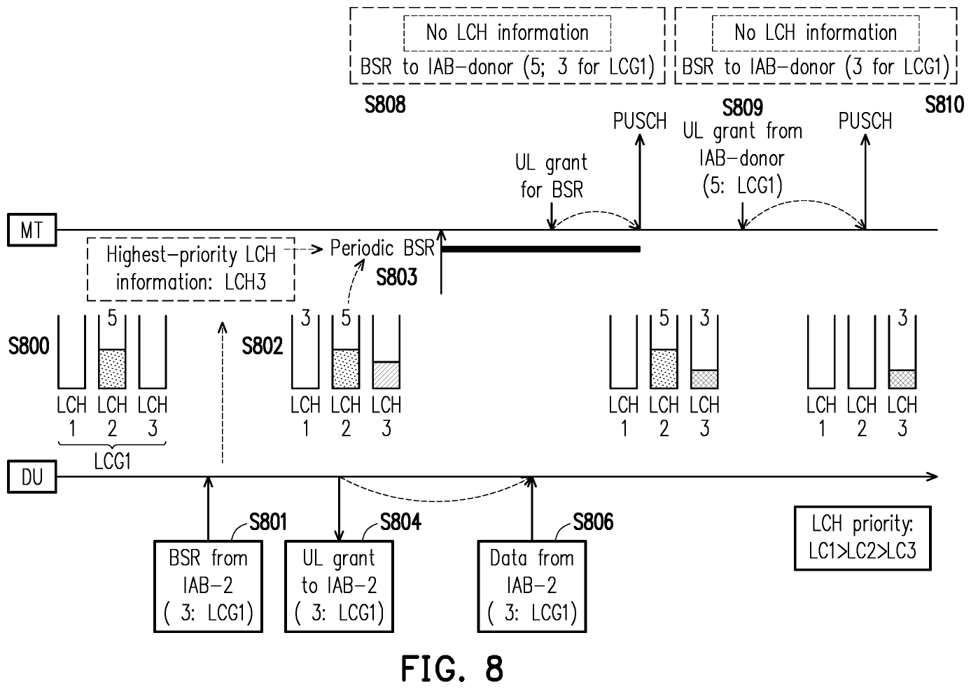

FIG. 8 illustrates a second alternative of the mechanism of FIG. 6 according to an embodiment of the disclosure. The mechanism of FIG. 8 is the same as the mechanism of FIG. 7 except for step S808 and S810, the BSR does not carry any LCH information. The BSR would carry LCH information only when the LCH priority of the preemptive BSR is larger than the LCH priority of the regular or periodic BSR. Since LCH1 is empty, there is no preemptive BSR to be triggered and thus the BSRs in step S808 and S810 do not contain any LCH information.

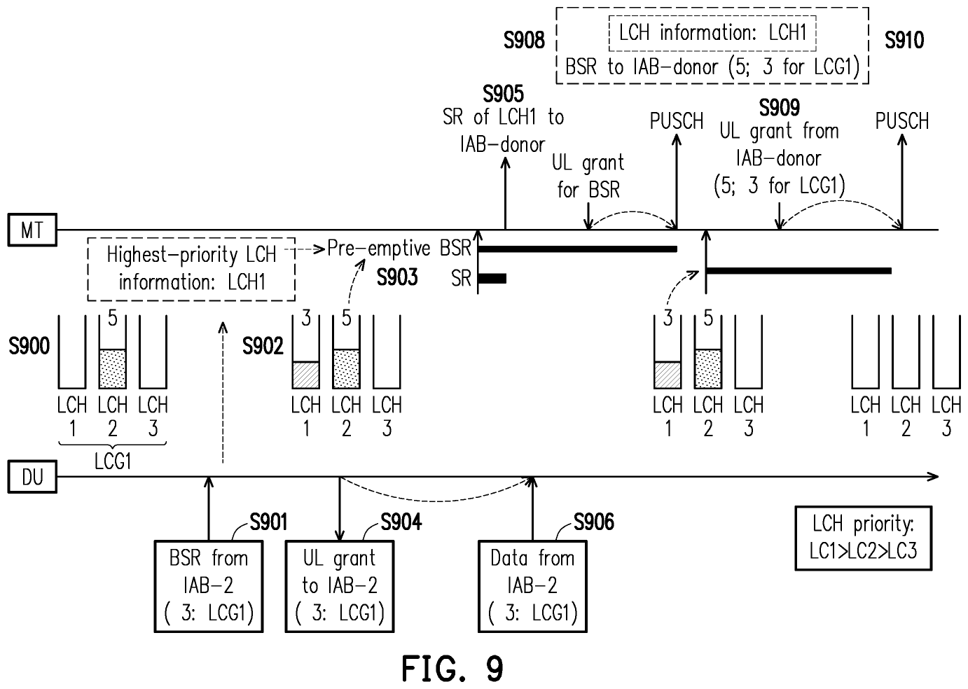

FIG. 9 shows a second example of a mechanism of triggering of pre-emptive BSR for predictive data. In this example it is assumed that LCH1 has a higher LCH priority than LCH2, and LCH2 has a higher LCH priority than LCH3, and LCH1, LCH2, and LCH3 are in the same LCG, namely LCG1. In step S900, it is assumed that LCG2 carries 5 units of data to be transmitted. In step S901, IAB-1 receives a regular BSR from IAB-2 indicating 3 units of data to be received in LCG1. In step S902, IAB-1 would determine which LCH has the highest priority LCH information, and in this example, the LCH having the highest priority LCH information is LCH1. In step S903, since LCH1 has the highest LCH priority in LCG1, and there is data to be transmitted via LCH1, the condition to trigger a pre-emptive BSR has been met and thus a pre-emptive BSR will be transmitted. In step S904, IAB-1 would transmit to IAB-2 an UL grant for the data to be received. In step S905, IAB-1 would transmit to IAB-donor a SR for LCH1 and would subsequently receive from IAB-donor an UL grant for the pre-emptive BSR. In step S906, IAB-1 would receive the actual 3 units of data from IAB-2. In step S908, IAB-1 would transmit the pre-emptive BSR to IAB-donor through PUSCH by using the UL grant received from IAB-donor, and the pre-emptive BSR would indicates 5 units of data in LCH2 and 3 units of data in LCH1. Also, in S908, the pre-emptive BSR would indicate the LCH with the highest priority LCH information which is LCH1 in this example. In step S909, IAB-1 would receive from IAB-donor an UL grant for the 5 units of data in LCH2 and 3 units of data in LCH1. In step S910, the IAB-1 would transmit the data to IAB-donor through PUSCH.

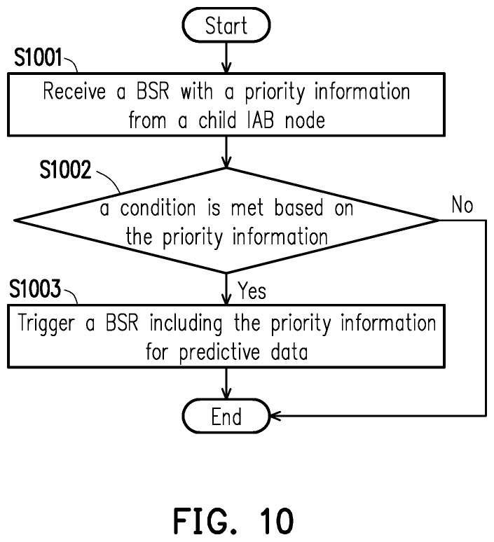

From the perspective of a network apparatus which could be any intermediate IAB node (e.g. IAB-1, IAB-2, IAB-3, and etc), the flow chart of the circumstance for trigger a pre-emptive BSR is shown in FIG. 10. Referring to FIG. 10, in step S1001, the intermediate IAB node would receive a BSR having a priority information from a child IAB node. In step S1002, the intermediate IAB node would determine whether a condition has been met based on the priority information. If the condition of step S1002 is not met, a pre-emptive BSR is not trigger, but a regular BSR or a periodic BSR would be triggered instead. If the condition of step S1002 has been met, then in step S1003, the intermediate IAB node would trigger a pre-emptive BSR which may include a priority information for predictive data. The priority information could be a LCH ID of the LCH to be used to transmit the predictive data or a priority value of the LCH to be used to transmit the predictive data.

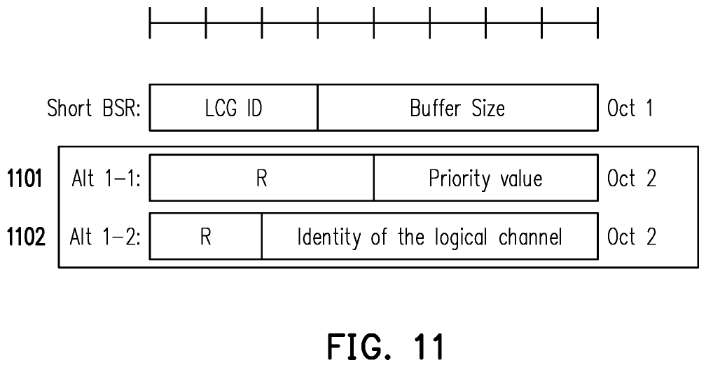

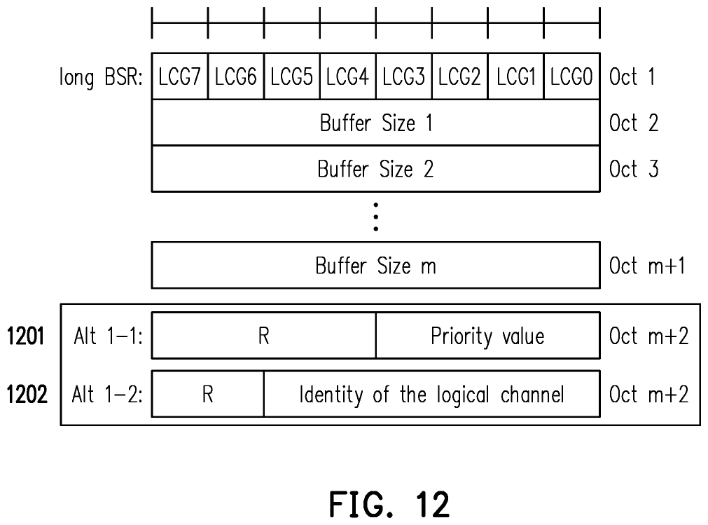

The disclosure provides a BSR format to accommodate the pre-emptive BSR, and the BSR format is shown in FIG. 11 & FIG. 12. In general, a BSR could be located in a MAC CE, and there could be a short BSR format as shown in FIG. 11 and a long BSR format as shown in FIG. 12. Referring to FIG. 11, the short BSR format of the pre-emptive BSR would further include a single octet (i.e. an 8-bit field) containing the priority information. The new octet could be one of the two alternative forms. For the first alternative 1101, the 8-bit field would include 4 bits of reserve field and 4 bits to indicate a priority value of an LCH. For the second alternative 1102, the 8-bit field would include 2 bits of reserve field and 6 bits to indicate an LCH ID. Thus, the priority information could be the priority value or the LCH ID depending on which alternative is being used.

Referring to FIG. 12, the long BSR format of the pre-emptive BSR would further include a single octet (i.e. an 8-bit field) containing the priority information. The octet would be attached toward the end of the long BSR format. The new octet could also be one of the two alternative forms. For the first alternative 1201, the 8-bit field would include 4 bits of reserve field and 4 bits to indicate a priority value of an LCH. For the second alternative 1202, the 8-bit field would include 2 bits of reserve field and 6 bits to indicate an LCH ID. Thus, the priority information could also be the priority value or the LCH ID depending on which alternative is being used.

The disclosure provides a second exemplary embodiment of the mechanism of triggering a pre-emptive BSR for the predictive data. For the second exemplary embodiment regular BSRs are to be cancelled or not triggered when the predictive data becomes available if the pre-emptive BSR for the predictive data and the regular BSR corresponds to the same event. Thus, when pre-emptive BSR is triggered, the regular BSR corresponding to the same event is cancelled since it is no longer deemed necessary. Therefore, when the actual data has arrived, the triggering of the pre-emptive BSR would replace the regular or periodic BSR.

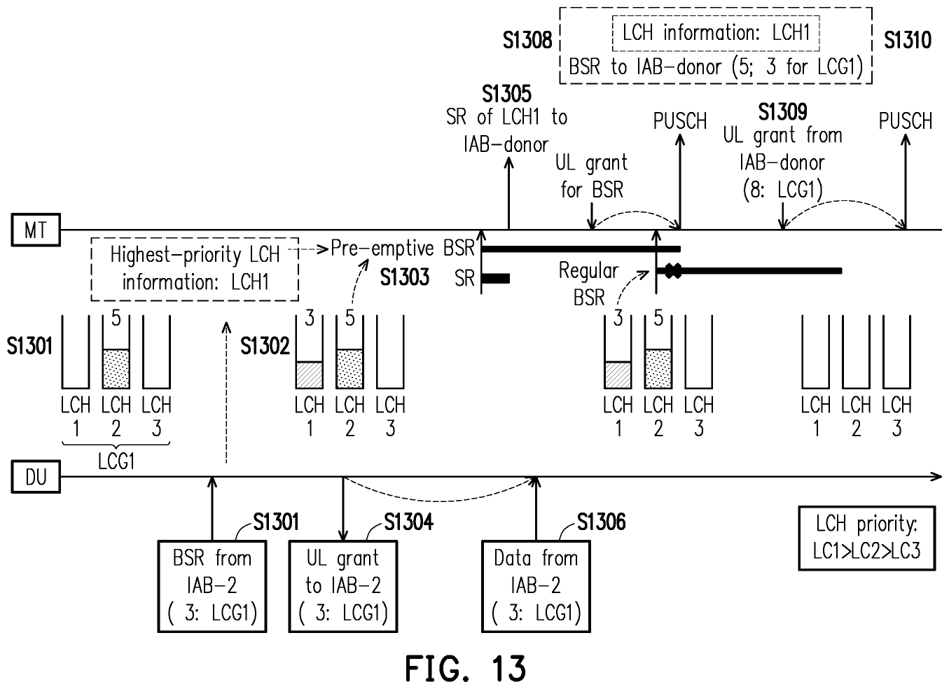

FIG. 13 shows an example of cancelling the BSR as a consequence of triggering a pre-emptive BSR for predictive data according to a second exemplary embodiment. This example assumes the same scenario of the first exemplary embodiment that LCH1 has a higher LCH priority than LCH2, and LCH2 has a higher LCH priority than LCH3, and LCH1, LCH2, and LCH3 are in the same LCG, namely LCG1. In step S1300, it is assumed that LCG2 carries 5 units of data to be transmitted. In step S1301, IAB-1 receives a regular BSR from IAB-2 indicating 3 units of data to be received in LCG1. In step S1302, IAB-1 would determine that the LCH1 has the highest priority LCH information. In step S1303, since the priority information indicating LCH1 which matches the condition of FIG. 10, a pre-emptive BSR will be transmitted. In step S1304, IAB-1 would transmit to IAB-2 an UL grant for the data to be received. In step S1305, IAB-1 would transmit to IAB-donor a SR for LCH1 and would subsequently receive from IAB-donor an UL grant for the pre-emptive BSR. In step S1306, IAB-1 would receive the actual 3 units of data from IAB-2. In step S1307, since the pre-emptive BSR was triggered in step S1303, then the regular BSR is no longer necessary and is thus cancelled. In step S1308, IAB-1 would transmit the pre-emptive BSR to IAB-donor through PUSCH by using the UL grant received from IAB-donor, and the pre-emptive BSR would indicates 5 units of data in LCH2 and 3 units of data in LCH1 for LCG1. Also, in S1308, the pre-emptive BSR would indicate the LCH with the highest priority LCH information which is LCH1 in this example. In step S1309, IAB-1 would receive from IAB-donor an UL grant for the 8 units of data for LCG1. In step S1310, the IAB-1 would transmit the data to IAB-donor through PUSCH.

In view of the aforementioned descriptions, the disclosure is suitable for being used in a 5G multi-hop wireless communication system and is able to limit the triggering of pre-emptive BSRs so as to reduce the signaling overhead associated with transmitting the predictive data.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method used by a network apparatus for triggering a buffer status report in a multi-hop wireless network, the method comprising:
receiving a first priority information of a logical channel (LCH) having a highest priority among a plurality of LCHs included in a first buffer status report (BSR) message which indicates a wireless resource to be needed for upstream data from a child node;
determining whether a condition is met based on the first priority information; and
triggering a pre-emptive BSR message comprising a second priority information in response to the condition having been met.

2. The method of claim 1 further comprising:
transmitting to the child node an UL grant which indicates the UL resource.

3. The method of claim 1, wherein the priority information comprising:
an identifier (ID) of an LCH.

4. The method of claim 1, wherein the priority information comprising:
a priority information of an LCH.

5. The method of claim 1, wherein the condition comprising:
whether the first priority information in the first BSR message indicates a higher priority than priorities of any other LCHs containing predictive or available data.

6. The method of claim 5, wherein the pre-emptive BSR indicates the priority information when the priority information of the first BSR message is greater than priorities of any other LCHs containing predictive or available data.

7. The method of claim 5, wherein the secondBSR message does not indicate the priority information when the priority information of the first BSR message is less than or equal to priorities of any other LCHs containing predictive or available data.

8. The method of claim 1, wherein the pre-emptive BSR is located in a media access control (MAC) control element (CE) transmitted through a physical uplink shared channel (PUSCH).

9. The method of claim 1, wherein the priority information is located in a last octet of the pre-emptive BSR.

10. A method used by a network apparatus for cancelling a triggered buffer status report in a multi-hop wireless network, the method comprising:
receiving a first buffer status report (BSR) message which indicates a wireless resource to be needed for a upstream data from a child node;
triggering a pre-emptive BSR message in response to the first BSR;
receiving the upstream data from the child node;
triggering a second BSR message in response to the upstream data; and
cancelling the second BSR in response to the pre-emptive BSR message and the second BSR message correspond to the same upstream data.

11. A network apparatus comprising:
a transmitter;
a receiver; and
a processor coupled to the transmitter and the receiver and configured at least to:
receive, via the receiver, a first priority information of a logical channel (LCH) having a highest priority among a plurality of LCHs included in a first buffer status report (BSR) message which indicates a wireless resource to be needed for upstream data from a child node;
determine whether a condition is met based on the first priority information; and
trigger a pre-emptive BSR message comprising the second priority information in response to the condition having been met.

12. The network apparatus of claim 11, wherein the processor is further configured to:
transmit, through the transmitter, an UL grant which indicates the UL resource to the child node.

13. The network apparatus of claim 12, wherein the priority information comprising:
an identifier (ID) of an LCH.

14. The network apparatus of claim 12, wherein the priority information comprising:
a priority information of an LCH.

15. The network apparatus of claim 11, wherein the condition comprising:
whether the first priority information in the first BSR message indicates a higher priority than priorities of any other LCHs containing predictive or available data.

16. The network apparatus of claim 15, wherein the pre-emptive BSR indicates the priority information when the priority information of the first BSR message is greater than priorities of any other LCHs containing predictive or available data.

17. The network apparatus of claim 15, wherein the second BSR message does not indicate the priority information when the priority information of the first BSR message is less than or equal to priorities of any other LCHs containing predictive or available data.

18. The network apparatus of claim 11, wherein the pre-emptive BSR is located in a media access control (MAC) control element (CE) transmitted through a physical uplink shared channel (PUSCH).

19. The network apparatus of claim 11, wherein the priority information is located in a last octet of the pre-emptive BSR.
